(19) United States
(12) Patent Application Publication
(10) Pub. No.: US 2004/0015617 A1
(43) Pub. Date: Jan. 22, 2004

(54) Flexible network interfaces and flexible data clocking

(76) Inventors: Onkar S. Sangha, San Jose, CA (US); Vijay Mahoshwari, Fremont, CA (US); Ed Kwan, Fremont, CA (US)

Correspondence Address: SKJERVEN MORRILL LLP, 25 METRO DRIVE, SUITE 700, SAN JOSE, CA, 95110, US

(21) Appl. No.: 09/770,345

(22) Filed: Jan. 25, 2001

(51) Int. Cl. G06F 13/00

(52) U.S. Cl. 710/10

(57) ABSTRACT

A network data processing system has a port that can be configured for any one of plural data formats, for example, for ATM or Frame Relay. The port configuration can be accomplished without re-manufacturing the network data processing system. The configuration can be accomplished by signals on external pins of integrated circuits forming the network processing system, and/or by software. In some embodiments, the port can be configured for any one of plural interfaces used for connection to physical layer devices, for example, UTOPIA or the serial interface. Receive and transmit clock signals can be configured to allow the receive or transmit data to be clocked on either rising or falling edges of the clock signals. Other parameters can also be configured.

### BACKGROUND OF THE INVENTION

The present invention relates to networks, and more particularly to methods and apparatus for processing network data.

FIG. 1 illustrates a prior art network data processing system 110 having ports 120.0, 120.1. Each of these ports 120 is connected to a respective network 130 through a respective physical layer device 140. The traffic on different ports 120 may conform to the same or different protocols. For example, the traffic on port 120.0 may consist of ATM cells while the traffic on port 120.1 may consist of Ethernet frames. System 110 transfers data between its different ports to deliver data to respective destinations.

Improved network processing systems are desirable.

### SUMMARY

In some embodiments of the present invention, a single port can receive and/or transmit data according to different protocols. For example, a single port can handle both ATM and Frame Relay traffic. The advantage provided in some embodiments is that the port can be connected to different types of physical layer devices. The port can be configured for a particular protocol without re-manufacturing the network data processing system. For example, the configuration can be accomplished by signals on external pins of the network processing system, or by software executed by the network processing system, or a combination of the two.

In some embodiments, the invention provides an apparatus comprising:

a port for receiving and/or transmitting network data;

a first circuit for providing a first signal identifying one of a plurality of data formats, wherein the first signal is to be defined by a signal provided to the apparatus from outside of the apparatus, and the first signal is changeable without re-manufacturing the apparatus; and

a hardwired (non-software-executing) circuit for processing data according to any one of said formats, wherein the circuit is responsive to the first signal to process data according to the format specified by the first signal.

In some embodiments, the invention provides a method comprising:

generating a first signal identifying one of a plurality of formats for network data received and/or transmitted on a port of an apparatus;

receiving and/or transmitting network data on the port, and processing the data by a hardwired circuit as having the format identified by the first signal;

wherein the first signal is defined by a signal provided to the apparatus from outside of the apparatus, and the first signal is changeable without re-manufacturing the apparatus.

In some embodiments, the invention provides an apparatus comprising:

a port for receiving data from a network via a physical layer device and/or transmitting data to a network via a physical layer device;

a first circuit for providing a first signal identifying one of types of interfaces between the port and physical layer devices, wherein the first signal is to be defined by a signal provided to the apparatus from outside of the apparatus, and the first signal is changeable without re-manufacturing the apparatus; and

a hardwired (non-software-executing) circuit, responsive to the first signal, for receiving and/or transmitting data on said port according to the type of interface specified by the first signal.

In some embodiments, the invention provides a method comprising:

generating a first signal identifying one of types of interfaces for transferring data between a port of a network data processing system and a physical layer device, wherein the first signal is to be defined by a signal provided to the network data processing system from outside of the network data processing system, and the first signal is changeable without re-manufacturing the network data processing system;

a port for receiving data from a network via a physical layer device and/or transmitting data to a network via a physical layer device;

receiving and/or transmitting data on said port by a hardwired (non-software-executing) circuit according to the type of interface specified by the first signal.

In some embodiments, the invention provides an apparatus comprising:

one or more terminals for carrying data, wherein the data are provided on the one or more terminals on a rising edge or a falling edge of a first clock signal; and

a first circuit for providing a first signal indicating whether the data are to be provided on the falling or rising edge of the first clock signal.

In some embodiments, the invention provides a method comprising:

generating a first signal indicating whether data are to be provided on one or more terminals on a falling or rising edge of a first clock signal; and

providing data on the one or more terminals in accordance with the first signal and the clock signal.

Other features and advantages of the invention are described below.

### BRIEF DESCRIPTION OF THE DRAWINGS

FIG. 1 is a block diagram illustrating a prior art network data processing system, physical layer devices, and networks.

FIG. 2 is a block diagram showing a network data processing system according to one embodiment of the present invention.

FIGS. 3 and 4 illustrate interface signals for prior art interfaces between network data processing systems and physical layer devices.

FIG. 5 is a block diagram of a flexible network interface circuit according to some embodiments of the present invention.

FIG. 6 is a block diagram of a configuration data block in the system of FIG. 5.

FIG. 7 is a block diagram of a portion of the system of FIG. 5.

FIGS. 8-11 are flow charts illustrating the operation of the system of FIG. 5 in some embodiment of the present invention.

FIG. 12 illustrates data storage in some embodiments of the system of FIG. 5.

FIGS. 13 and 14 illustrate frame formats in some embodiments of the system of FIG. 5.

FIG. 15 is a block diagram illustrating a clocking scheme for some embodiments of the system of FIG. 5.

### DESCRIPTION OF PREFERRED EMBODIMENTS

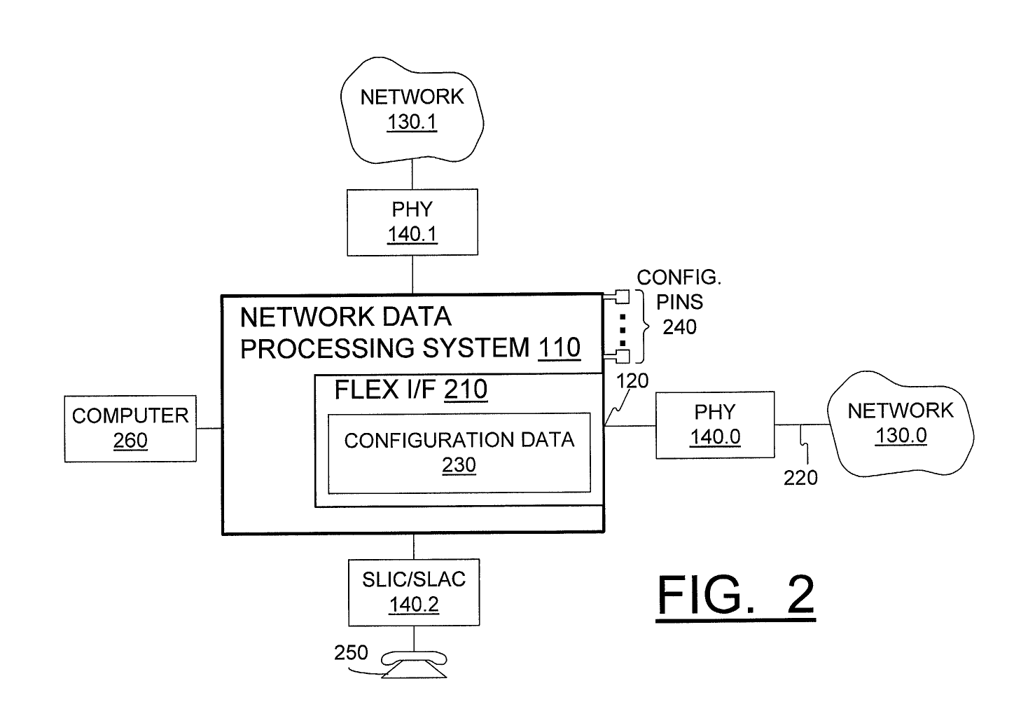

FIG. 2 illustrates a network data processing system 110 according to some embodiments of the present invention. Flexible network interface block 210 in system 110 processes data received and transmitted on a port 120. Port 120 is connected to a physical layer device 140.0. Physical layer device 140.0 receives data from network 130.0, and transmits data to the network, via a network media link 220. The flexibility of block 210 allows the port 120 to be configured for different kinds of physical layer devices 140.0 and links 220. In some embodiments, port 120 can be configured for any one of the following interfaces:

(1) UTOPIA interface defined in “UTOPIA Specification, Level 1, Version 2.01” (The ATM Forum Technical Committee, Mar. 21, 1994) or “Utopia Level 2, Version 1.0” (The ATM Forum Technical Committee, June 1995);

(2) serial interface.

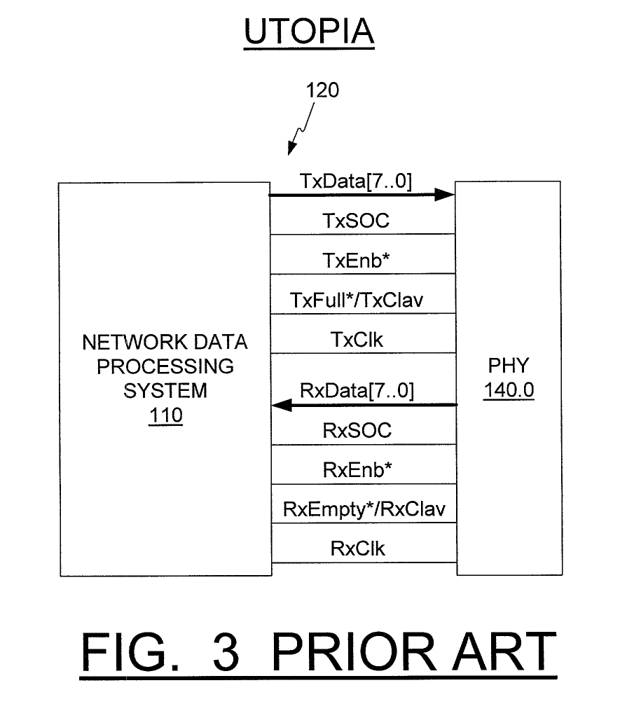

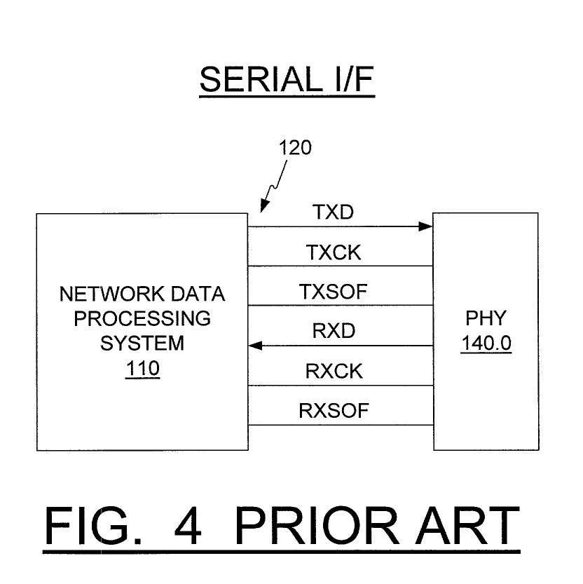

These interfaces are illustrated in FIGS. 3 and 4, and described in Addendum B below.

When port 120 is configured for the serial interface, block 210 can be configured for different data formats including, for example, ATM (asynchronous transfer mode), Frame Relay, HDLC, T1, E1 and others. For a description of ATM, Frame Relay, HDLC, T1 and E1, see B. Forouzan, “Data Communications and Networking” (2nd ed. 2001); R. Freeman, “Telecommunication System Engineering” (1996); W. Stallings, “ISDN and Broadband ISDN with Frame Relay and ATM (4th ed. 1999). In some embodiments, port 120 can be connected to any one of the following physical layer devices: (1) a device of type MTC-20146 available from Alcatel Microelectronics (France); (2) a device built using a chip set of type G7070-174-001DA or G7070-174-002DA available from GlobeSpan, Inc. of Red Banks, N.J. Other types of physical layer devices, known or to be invented, can also be used. This flexibility allows the port 120 to communicate with different types of networks 130.0 over different types of links 220. Examples of possible links include a twisted wire cable used for telephone communications and for DSL (Digital Subscriber Loop), optical links, and other types of links, known or to be invented. Both wide area networks 130.0 (WAN) and local area networks (LAN) can be supported.

In interface block 210, block 230 stores configuration data that define the configuration of port 120 and interface 210. The configuration data are defined by: (1) signals on one or more external pins 240 of system 110, and/or (2) software. Block 210 includes one or more computer processors (not shown in FIG. 2) that perform their functions by executing software instructions. The software can be changed without remanufacturing the system 110. Other functions of block 210 are “implemented in hardware” (“hardwired”), that is, these functions are performed by circuits that do not execute software instructions. The particular division of functions between software and “hardware” (that is, non-software-executing hardware), provides both flexibility and high performance.

Network data processing system 110 may have other ports connected to physical layer devices. In FIG. 2, system 110 has a port connected to a physical layer device 140.1 connected to network 130.1. System 110 also has a port connected to a SLIC or SLAC device 140.2 connected to a telephone 250. The connections to physical layer devices 140.1, 140.2 may or may not use flexible network interfaces similar to interface 210.

In FIG. 2, system 110 is also connected to a computer 260 via a PCI bus.

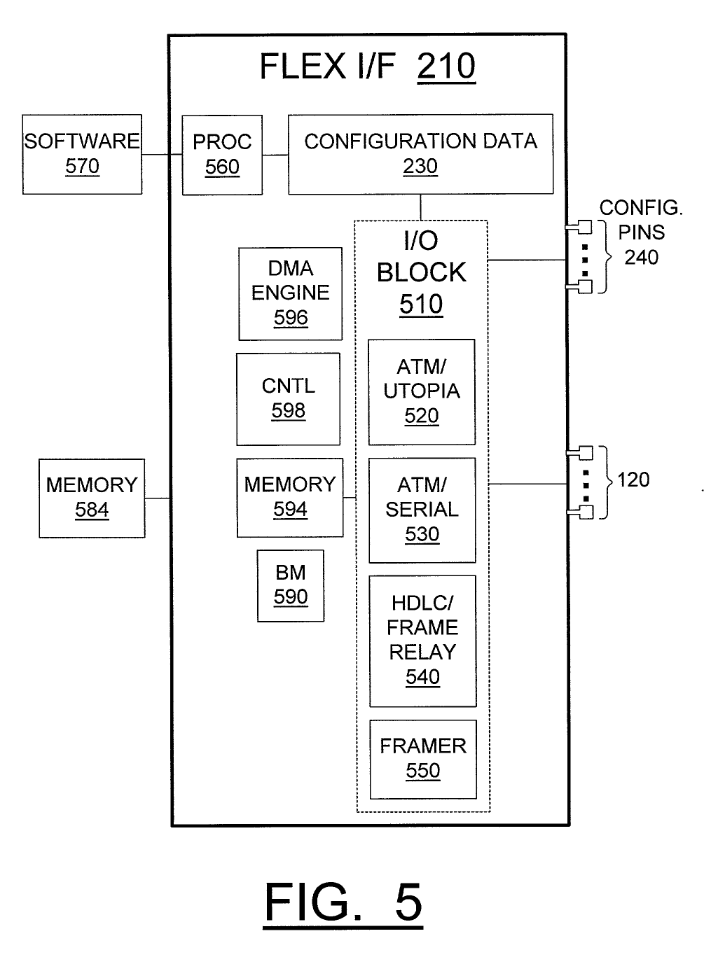

FIG. 5 illustrates flexible network interface block 210 in detail. I/O block 510 of block 210 is “implemented in hardware”, i.e. hardwired (this block does not execute software instructions). I/O block 510 receives and transmits data on port 120. In the embodiment of FIG. 5, I/O block 510 includes the following blocks:

1) block 520 for receiving and transmitting ATM cells when the port 120 is configured for the UTOPIA interface (FIG. 3);

2) block 530 for receiving and transmitting ATM cells when the port 120 is configured for the serial interface (FIG. 4);

3) block 540 for receiving and transmitting HDLC or Frame Relay frames when port 120 is configured for the serial interface;

4) block 550 for receiving and transmitting frames when port 120 is configured for the serial interface. Block 550 can receive and transmit frames that do not conform to the HDLC or Frame Relay protocols. The frame format for block 550 can be configured by configuration data in block 230.

A computer processor 560 in block 210 executes software instructions schematically shown at 570. The software can be manufactured before the network data processing system 110 begins execution. The software can be loaded to system 110 from a memory (not shown) connected to the system 110 via a local (non-network-media) bus, or via a network. The software can be changed without remanufacturing the system 110. In some embodiments, flexible network interface 210 is part of an integrated circuit. In other embodiments, flexible network interface 210 is assembled from a number of integrated circuits and/or discrete components.

Configuration data in block 230 define which of the blocks 520, 530, 540, 550 is activated. The configuration data may also define the frame format for the framer interface block 550, and may define other parameters, as described below.

Configuration data in block 230 can be changed without remanufacturing the circuit 210. In some embodiments, some of the configuration data 230 are provided by configuration pins 240 but can be overwritten by software.

System 110 may include other software processors (i.e. processors that execute software instructions) which may write and/or read the configuration data in block 230.

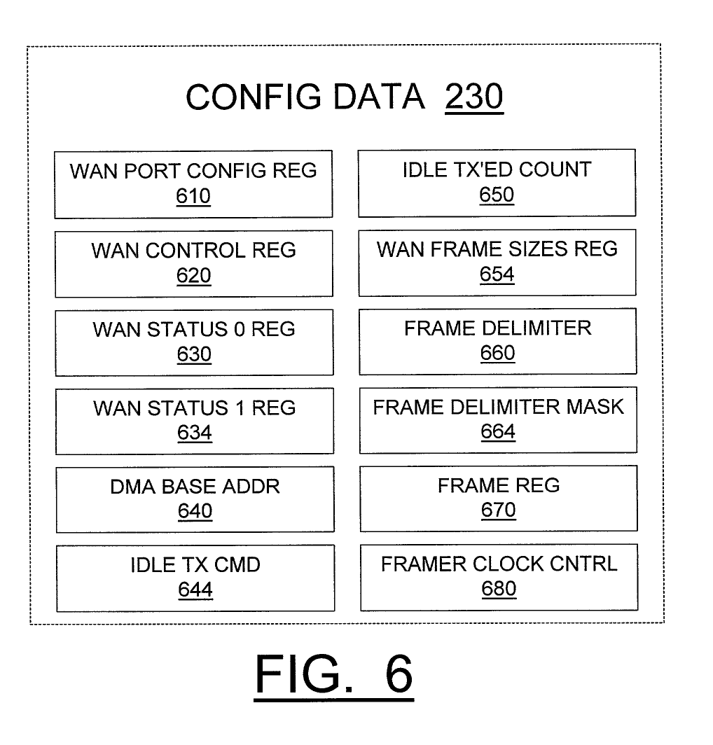

FIG. 6 illustrates registers that store configuration data in block 230 in some embodiments. “WAN port configuration register” 610 stores signals provided on pins 240 that define which of the blocks 520, 530, 540, 550 is active. In the embodiment being described, the term “WAN” in the name of the register 610 and other registers is used because the protocols for which the port 120 can be configured (ATM, HDLC, Frame Relay) are used extensively in wide area networks. For this reason, the port 120 is sometimes called a WAN port. However, the invention is not limited to WANs or any particular protocols.

Register 610 can be overwritten by software.

The remaining registers in FIG. 6 store other configuration data, as described below. See in particular Addendum A. A detailed description of these registers is provided for illustration and is not limiting.

Random access memory 584 (FIG. 5) stores data received on port 120 and other ports of system 110 before the data are transmitted. The data are processed as needed before transmission. Processing may include address translation, compression or decompression, or any other processing. In some embodiments, memory 584 is external to the integrated circuit containing the flexible interface block 210.

Buffer manager 590 of flexible interface 210 maintains buffers in memory 584. Many types of buffer managers can be used. One suitable buffer manager is described in U.S. patent application Ser. No. ______, Attorney Docket No. M-9564 US, entitled “Buffer Management for Communication Systems”, filed by O. Sangha, et al. on the same day as the present application and incorporated herein by reference.

Memory 594 in flexible network interface 210 stores data received and transmitted on port 120. Memory 594 provides intermediate data storage as the data flow between memory 584 and port 120. The data in memory 594 can be processed by software.

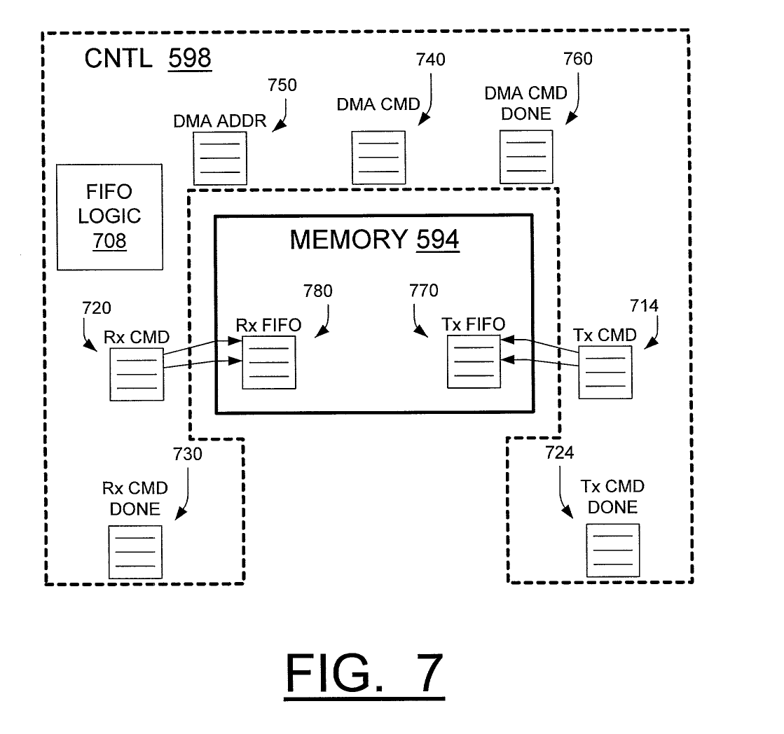

DMA engine 596 (hardwired) transfers data between memory 594 and memory 584. Hardwired control block 598 includes FIFO logic 708 (FIG. 7) which maintains FIFOs 714, 720, 724, 730, 740, 750, 760 described below.

Memory 594 is used to store: (1) a transmit FIFO 770 (FIG. 7) for data to be transmitted on port 120, and (2) a receive FIFO 780 for data received on port 120. The FIFOs 770, 780 are maintained by software (e.g. by processor 560). In some embodiments each of these FIFOs has 8 entries, and each entry is 64 bytes wide. The invention is not limited to such embodiments.

Transmit command FIFO 714 stores transmit commands for I/O block 510. Each transmit command includes a pointer to data in FIFO 770 and the number of bytes to be transmitted. In some embodiments, FIFO 714 is 8-deep (through other depths are possible). The format of each transmit command is described in Addendum A, Table A10.

Receive command FIFO 720 stores receive commands for I/O block 510. Each receive command includes a pointer to a free area in receive FIFO 780, and the number of bytes in this area. In some embodiments, FIFO 720 is 8-deep, though this is not necessary. The format of each receive command is described in Addendum A, Table A9.

Memory 594 can be double-ported. One port provides access to microprocessor 560 and the other port provides access to I/O block 510 and DMA engine 596.

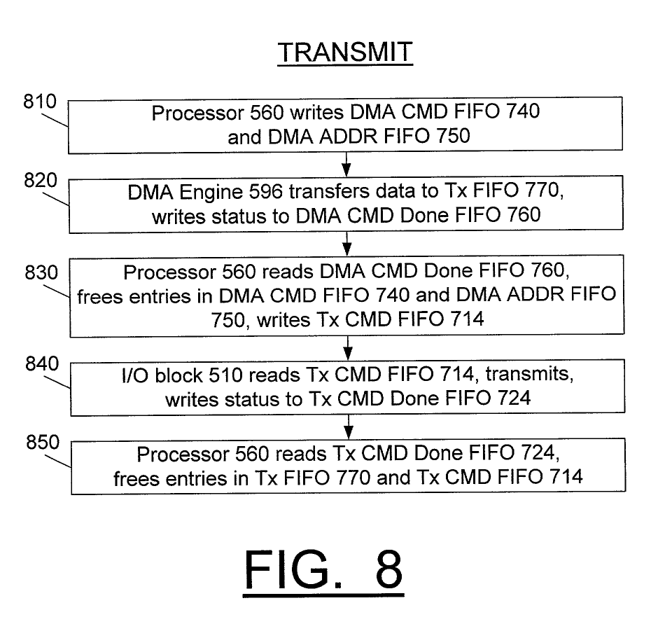

FIG. 8 illustrates data transmission operations that can be performed by suitably programming the processor 560. At stage 810, microprocessor 560 gets a pointer to a block of data in memory 584. This data must be transmitted on port 120. The pointer is provided by buffer manager 590. (In some embodiments, buffer manager 590 is hardwired). Buffer manager 590 also provides the size of the data block to be transmitted. Microprocessor 560 writes a command to DMA command FIFO 740 to transfer the data from memory 584 to transmit FIFO 770. As indicated in Addendum A, Table A5, the command includes a memory 594 destination address “addr” to which the data are to be written. The command also includes the number (“wcount”) of 32-bit words to be written. Processor 560 also writes to DMA address FIFO 750 (Table A6) the address in memory 584 of the data to be transferred to FIFO 770. The FIFO 750 is used to hold the address because in the embodiment being described the data bus (not shown) used to write the FIFOs is only 32-bits wide. In other embodiments, FIFO 750, 740 can be combined into a single FIFO.

In the embodiment of Addendum A, the FIFO 750 contains only the least significant bits of the address in memory 584. The most significant bits are stored in a base register 640 (FIG. 6 and Table A7).

At stage 820, DMA engine 596 reads the DMA command in FIFO 740 and the DMA address in FIFO 750, and executes the command. The DMA engine transfers the data from memory 584 to memory 594. When the transfer is complete, DMA engine 596 writes the command completion status to DMA command done FIFO 760 (Table A8). In some embodiments, each time this FIFO is written, an interrupt is generated to microprocessor 560. In other embodiments, an interrupt is generated only when this FIFO changes from empty to non-empty. In some embodiments, no interrupt is generated.

Processor 560 reads DMA command done FIFO 760 (stage 830). The processor can be programmed to read this FIFO periodically and/or in response to an interrupt. When an entry in this FIFO indicates completion of the command, microprocessor 560 writes suitable commands to transmit command FIFO 714 (Table A10).

Microprocessor 560 can be programmed to process the data to be transmitted before writing the transmit commands. For example, processor 560 can be programmed to perform ATM segmentation functions. More particularly, processor 560 can obtain from buffer manager 590: (a) a data packet to be transmitted over an ATM network, and (b) information identifying an ATM virtual circuit. Processor 560 reads from memory 594 information specifying how the data are to be transmitted on this circuit, for example, (i) which ATM Adaptation Layer is used (AAL5 or AAL2, etc.), (ii) whether or not the data are to be scrambled, and so on. Processor 560 builds ATM headers in transmit FIFO 770, calculates appropriate check sums (e.g. CRC32 for AAL5), scrambles the data payload, and segments the packet, to build ATM cells in transmit FIFO 770.

At stage 840, I/O block 510 reads the transmit command FIFO 714 and executes the transmit commands by transmitting the corresponding data in FIFO 770. When a command has been executed, the I/O block 510 writes the command completion status to transmit command done FIFO 724 (Table A12). In some embodiments, each time this FIFO is written, an interrupt is generated to microprocessor 560. In other embodiments, an interrupt is generated only when the FIFO changes from empty to non-empty. In some embodiments, no interrupt is generated.

Microprocessor 560 reads the transmit command done FIFO 724 (stage 850). The microprocessor can be programmed to read this FIFO periodically and/or in response to an interrupt. When all of the data in an entry in transmit FIFO 770 has been transmitted, the microprocessor deallocates the entry.

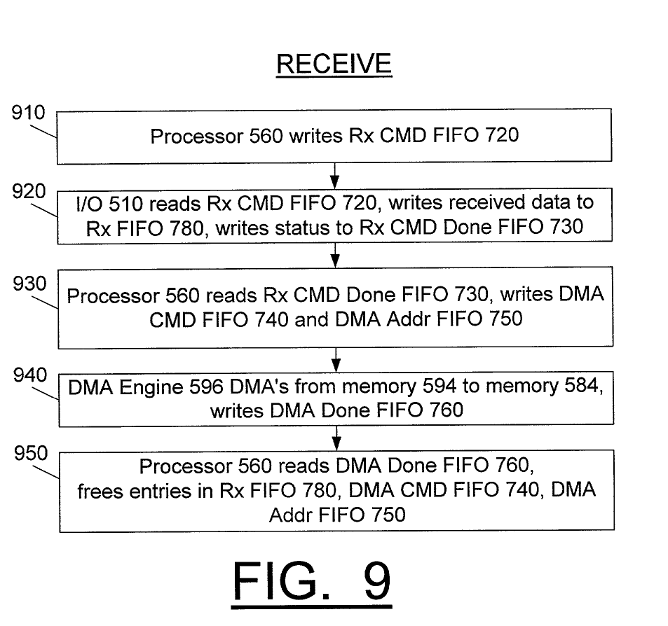

FIG. 9 illustrates a data receive operation for one embodiment. At stage 910, microprocessor 560 writes receive commands to receive command FIFO 720 (Table A9). As indicated at 920, when I/O block 510 needs to store receive data, I/O block 510 reads a receive command from FIFO 720 and stores the received data in a memory area specified by the receive command. Upon completion of each command, I/O block 510 writes the completion status to receive command done FIFO 730 (see Table A11). In some embodiments, each time this FIFO is written, an interrupt is generated to microprocessor 560. In other embodiments, an interrupt is generated only when the FIFO changes from empty to non-empty. In some embodiments, no interrupt is generated.

As indicated at 930, microprocessor 560 reads receive command done FIFO 730. The microprocessor can be programmed to read this FIFO periodically and/or in response to an interrupt. When an entry in this FIFO indicates new data in the receive FIFO 780, the microprocessor 560 deallocates the corresponding entry in receive command FIFO 720, and processes the data as needed. For example, the microprocessor may perform data descrambling and CRC computations, as described in U.S. patent application Ser. No. ______, Attorney Docket No. M-9565 US, entitled “COMPUTATION OF CHECKSUMS AND OTHER FUNCTIONS WITH THE AID OF SOFTWARE INSTRUCTIONS”, filed on ______, incorporated herein by reference. Examples of other processing include the transmission convergence function for the ATM-over-serial interface (block 530 in FIG. 5). This function determines the beginning of each ATM cell based on the HEC (header error-control) fields of the cells. See W. Stallings, “ISDN and Broadband ISDN with Frame Relay and ATM” (4 Ed. 1999), pages 433-434, incorporated herein by reference.

Microprocessor 560 can also be programmed to perform ATM reassembly functions. The AAL type (AAL5, AAL2, etc.) can be stored in memory 594 for each ATM virtual circuit when the circuit is set up.

Microprocessor 560 obtains from buffer manager 590 addresses at which received data can be stored in memory 584. Microprocessor 560 writes suitable commands to DMA command FIFO 740, and suitable addresses to DMA address FIFO 750.

At stage 940, DMA engine 596 reads the DMA command FIFO 740 and DMA address FIFO 750, and executes the DMA command by transferring the data from receive FIFO 780 to memory 584. DMA engine 596 writes the completion status to DMA command done FIFO 760.

Microprocessor 560 reads the DMA command done FIFO 760 (stage 950), and deallocates the corresponding entries in FIFOs 740, 750. When all of the data have been transferred from an entry in receive FIFO 780, microprocessor 560 deallocates the entry in FIFO 780. In some embodiments, memory 594 has two separate banks for the respective transmit and receive FIFOs 770, 780. The memory access logic (not shown) allows the I/O block 510 to read the memory bank containing the transmit FIFO 770 but not to write that bank, and to write the bank containing the receive FIFO 780 but not to read that bank. The memory access logic allows microprocessor 560 to read the bank containing receive FIFO 780 but not to write that bank, and to write the bank containing the transmit FIFO 770 but not to read that bank. The size and complexity of the memory access logic can thus be reduced.

Microprocessor 560 can be programmed to implement many different functions and to adapt the system 110 to protocol changes without remanufacturing the system 110.

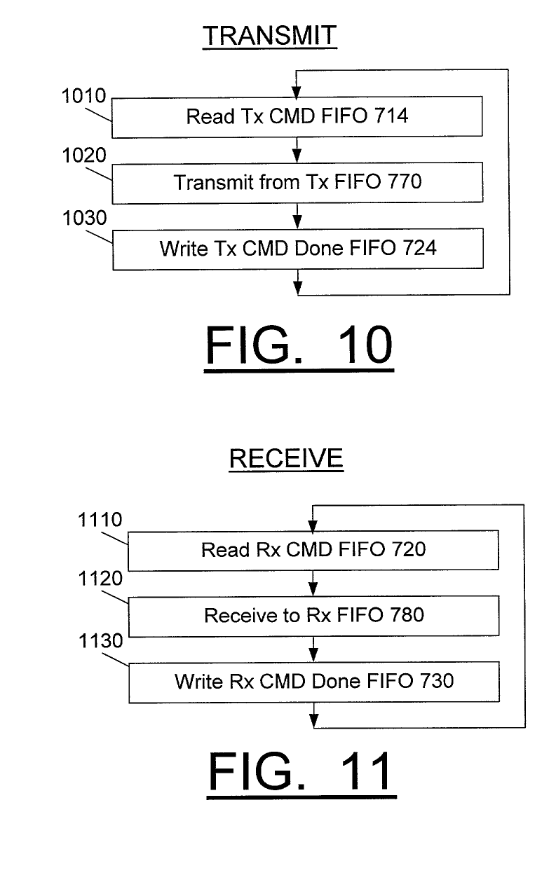

FIG. 10 summarizes the transmit operation of I/O block 510. This operation corresponds to stage 840 (FIG. 8). I/O block 510 reads the transmit command FIFO 714 (stage 1010 in FIG. 10), transmits the corresponding data (stage 1020), and writes the transmit command done FIFO 720 (stage 1030). These operations are performed by one of blocks 520, 530, 540, 550 (FIG. 5) as defined by configuration data in block 230. These operations may overlap, for example, reading the transmit command FIFO 714 may overlap with transmitting data for a previous transmit command.

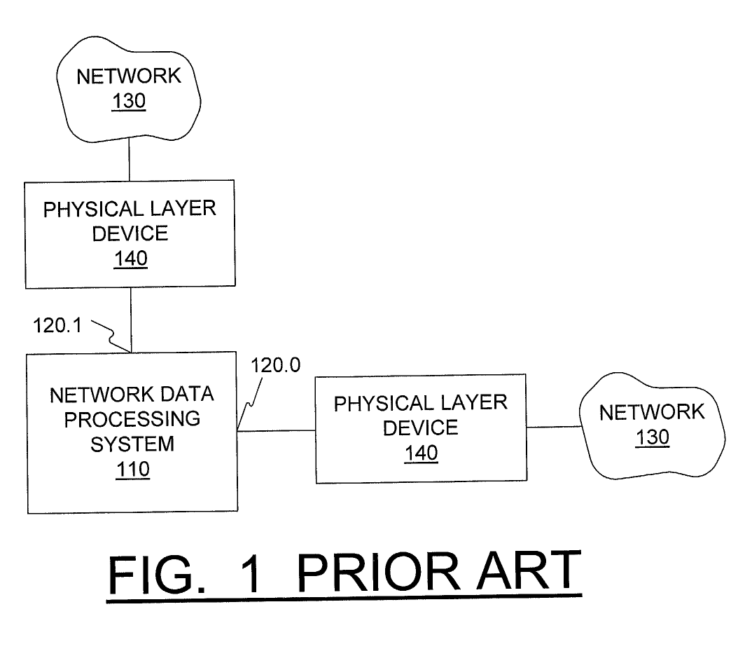

The receive operation is illustrated in FIG. 1. This operation corresponds to stage 920 (FIG. 9). I/O block 510 reads the receive command FIFO 720 (stage 1110), writes the received data to the corresponding location of memory 594 (stage 1120), and writes the received command done FIFO 730 (stage 1130). These operations may overlap.

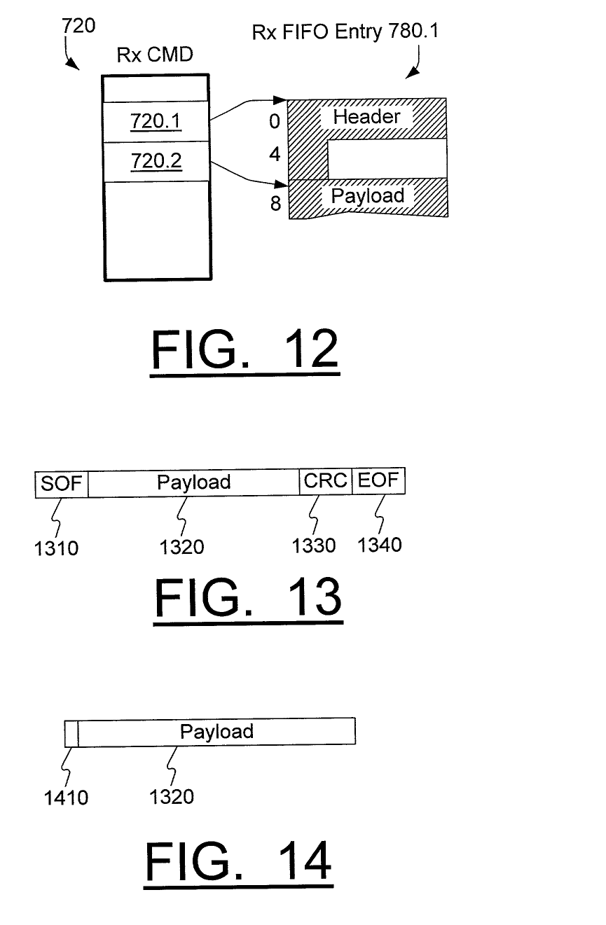

Receive FIFO 780 and transmit FIFO 770 can be replaced by other data structures merely by changing the software executed by microprocessor 560. Memory usage can be adapted to the particular memory circuitry. For example, FIG. 12 illustrates an ATM cell stored in an entry 780.1 of receive FIFO 780. In this embodiment, memory 594 is accessed 32 bits (four bytes) at a time. The memory access is faster if the 32 bits are on a four byte boundary. Each entry in FIFO 780 starts on a four byte boundary. Each entry is 64 bytes long. An ATM cell is stored in a single entry. The cell header is stored in bytes 0-4 of the entry. The payload is stored in bytes 8-55. A command 720.1 in receive command FIFO 720 points to the header, and specifies five bytes. The next command 720.2 in FIFO 720 points to the payload and specifies 48 bytes. The payload processing by microprocessor 560, such as descrambling and CRC32 computation, proceeds therefore faster.

Microprocessor 560 can store ATM cells in transmit FIFO 770 in a similar fashion, with each of the header and the payload being stored on a 4-byte boundary and with two transmit commands in FIFO 714 used for a single cell.

When performing the operations of FIGS. 10, 11, HDLC/Frame Relay block 540 performs bit stuffing on the data before the data are transmitted. Bits stuffing is performed to prevent a frame delimiter pattern from occurring anywhere other than at the beginning of the frame. See, for example, B. Forouzan, “Data Communications and Networking” (2^{nd} ed. 2001), pages 344-345, incorporated herein by reference. Block 540 performs bit removal on received data to discard the stuffed bits.

If the port 120 is configured for the serial interface (block 530, 540, or 550 is active), port 120 may be connected to physical layer devices 140.0 which use start of frame signals (TXSOF, RXSOF; see FIG. 4) to indicate the beginning of each frame or ATM cell. Alternatively, port 120 may be connected to physical layer devices which do not use start of frame signals. If the start of frame signals are not used, the start of each frame or cell of the received data is determined as follows.

If the ATM/serial block 530 is active, the start of each cell is determined by software performing the transmission convergence function on data in receive FIFO 780, as described above.

If the HDLC/Frame Relay block 540 is active, this block determines the start of frame using the start of frame delimiter.

The idle pattern transmitted between the frames can be configured for block 540 via frame register 670 as either 7E or FF hexadecimal (Addendum A, Table A18, bit 3).

For each block 520, 530, 540, 550, when microprocessor 560 writes data to transmit FIFO 770, microprocessor 560 identifies the beginning or the end of each frame in transmit command FIFO 714 (Addendum A, Table A10, bit 17). Block 540 inserts the frame delimiter at the start of each frame when the frame is transmitted.

Framer block 550 can process different frame formats. The frame format is determined by configuration data in block 230. In FIG. 13, the frame includes a start of frame delimiter 1310, a payload 1320, a check sum (for example, CRC) 1330, and an end of frame delimiter 1340. Some of these fields may be absent. In some embodiments, the length and value of the starting delimiter 1310, the length and value of the ending delimiter 1340, the length of the entire frame, the length of check sum 1330, and the type of the check sum (for example, the CRC generator polynomial) are defined by the configuration data in block 230. Framer 550 identifies the beginning of the frame and computes the CRC based on the configuration data.

In the embodiment of Addendum A, framer 550 does not perform the CRC computation, so the length and size of field 1330 are not configurable by block 230. The frame size is configurable (Table A15). The length and size of the starting delimiter 1310 are also configurable, using the frame delimiter register 660 (Table A16) and the delimiter mask register 664 (Table A17). The ending delimiter 1340 is not configurable. CRC field 1330 and the ending delimiter may or may not be present in the frame. If present, they are treated as part of the payload 1320. (This embodiment does not distinguish between the payload, the CRC, and the ending delimiter.)

FIG. 14 illustrates another frame format that can be handled by the framer 550 of Addendum A. The starting delimiter is absent or consists of a single framing bit 1410. A single framing bit is used, for example, in T1 frames described in R. Freeman, “Telecommunication System Engineering” (3^{rd} ed. 1996), pages 349-352, incorporated herein by reference; see also B. Forouzan, “Data Communications and Networking” (2^{nd} ed. 2001), pages 252-253, incorporated herein by reference. Frame register 670 (Table A18), bit 5, specifies whether the frame bit is present in the frames. The transmit command in FIFO 714 (Table A10), bit 18, specifies whether the frame bit must be transmitted at the beginning of the corresponding block of data in transmit FIFO 770. The frame bit value is specified in bit 18 of the transmit command.

In frame register 670 (Table A18), the “Frame Mode” bit 4 specifies if the frame format is that of FIG. 13 or that of FIG. 14. If this bit indicates the format of FIG. 14, framer 550 determines the beginning of each frame of the received data using the start of frame signal RXSOF (FIG. 4). Frame register 670, bit 31 (Table A18), defines whether the start of frame signal is active high or low. Framer 550 checks for the frame bit when the start of frame signal RXSOF is asserted. The frame bit is expected to be 1 if bit 31 is 0; the frame bit is expected to be 0 if bit 31 is 1. The frame bit is not written to receive FIFO 780.

Framer 550 also checks the frame size (Table A15) to determine if the received data are valid. Invalid data are discarded by framer 550 in some embodiments. The frame size is checked both in the case of FIG. 13 and in the case of FIG. 14.

A predetermined value in frame size register 654 (Table A15) indicates a variable frame size. If the frame size is variable, framer 550 does not check the frame size.

In some embodiments, configuration data in block 230 define minimum and/or maximum frame sizes. Framer 550 checks that the frame size conforms to the configuration data.

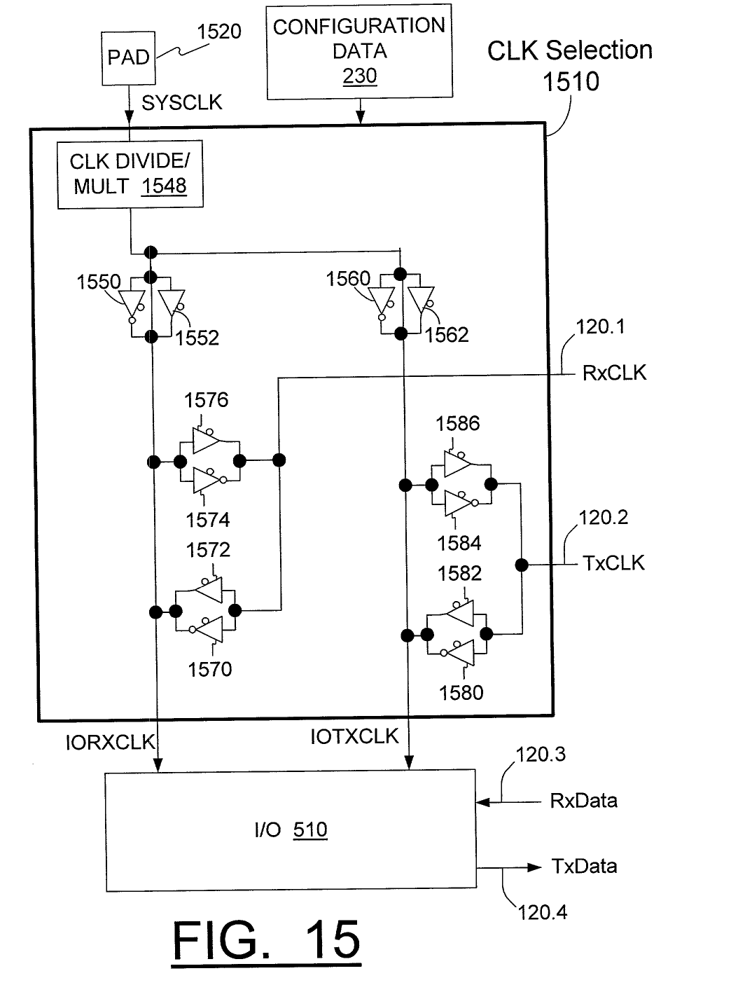

Some embodiments allow the software and/or the signals on external pins 240 to configure the receive and transmit clocks for I/O block 510. FIG. 15 illustrates one such embodiment. Port 120 includes a pin 120.1 which carries a receive clock signal RxCLK. This may be the signal TxClk (FIG. 3) for UTOPIA, or TXCK (FIG. 4) for the serial interface. Port 120 includes pin or pins 120.3 that carry receive data RxData. (This corresponds to signals RxData in UTOPIA, RXD in case of the serial interface.) I/O block 510 samples RxData on a positive or negative edge (i.e. rising or falling edge) of clock RxCLK.

Similarly, port 120 includes a pin 120.2 that carries the transmit clock TxCLK. Port 120 includes output pin of pins 120.4 that carry transmit data TxData. I/O block 510 provides the transmit data on pin of pins 120.4 on the rising or falling edge of clock TxCLK.

Flexible interface 210 can be configured to receive the clocks RxCLK, TxCLK from the physical layer device 140.0 (FIG. 2), or to generate these clocks from a clock SYSCLK generated by system 110, depending on configuration data in block 230 (in register 680 of FIG. 6).

More particularly, pins 120.1, 120.2 are connected to inputs of clock selection circuit 1510. Circuit 1510 also receives SYSCLK on a pin 1520. Based on configuration data in block 230, circuit 1510 selects one of signals SYSCLK, RxCLK, TxCLK to generate a clock signal IORXCLK which clocks the receive operations of I/O block 510. Clock IORXCLK can be generated as any one of the following signals:

TABLE 1

| | |
|---|---|
| 1. | IORXCLK can be equal to clock SYSCLK or a multiple or a |
| | fraction of SYSCLK. Therefore, the clock speed of clock |
| | IORXCLK can be controlled. |
| 2. | IORXCLK can be equal to RXCLK. |
| 3. | IORXCLK can be equal to TxCLK. |
| 4. | IORXCLK can be the inverse of any one of the signals described |
| | as items 1, 2, and 3 in this Table 1. |

The transmit operations of I/O block 510 are clocked by clock IOTXCLK. Clock IOTXCLK is generated by clock selection circuit 1510 in response to configuration data in block 230. Any one of the options 1, 2, 3, 4 of Table 1 can be used for clock IOTXCLK. Thus, clock IOTXCLK can be the clock SYSCLK, or its multiple or a fraction, or it can be RxCLK, or TxCLK, or the inverse of any of these clocks.

Clock selection circuit 1510 is constructed as follows in one embodiment. Pin 1520 is connected to an input of clock divide/multiply circuit 1548 which can adjust the clock frequency based on configuration data in block 230. The output of circuit 1548 is connected to inputs of tri-state inverter 1550 and tri-state buffer 1552. The outputs of inverter 1550 and buffer 1552 are connected to output IORXCLK.

The output of circuit 1548 is also connected to inputs of tri-state inverter 1560 and tri-state buffer 1562. The outputs of inverter 1560 and buffer 1562 are connected to output IOTXCLK.

Pin 120.1 (RxCLK) is connected to inputs of tri-state inverter 1570 and tri-state buffer 1572, and to outputs of tri-state inverter 1574 and tri-state buffer 1576. The outputs of inverter 1570 and buffer 1572 and the inputs of inverter 1574 and buffer 1576 are connected together and to output IORXCLK.

Pin 120.2 (TxCLK) is connected to inputs of tri-state inverter 1580 and tri-state buffer 1582, and to outputs of tri-state inverter 1584 and tri-state buffer 1586. The outputs of inverter 1580 and buffer 1582 and the inputs of inverter 1584 and buffer 1586 are connected together and to output IOTXCLK.

Inverters 1550, 1560, 1570, 1574, 1580, 1584 and buffers 1552, 1562, 1572, 1576, 1582, 1586, are controlled by configuration data in block 230.

This circuit provides the following capabilities:

OPTION 1. Port 120 can be connected to a physical layer device that generates the receive clock RxCLK and the transmit clock TxCLK. In this case, configuration data in block 230 are set up to disable the inverters and buffers 1550-1562, 1574, 1576, 1584, 1586. Clock IORXCLK is either RxCLK (buffer 1570 is enabled and inverter 1572 is disabled) or the inverse of RxCLK (inverter 1572 is enabled and buffer 1570 disabled). Clock IOTXCLK is either TxCLK (buffer 1582 is enabled and inverter 1580 is disabled) or the inverse of TxCLK (inverter 1580 is enabled and buffer 1582 is disabled). Hence, I/O block 510 can sample the receive data either on the rising or the falling edge of clock RxCLK, and can transmit data either on the rising or the falling edge of clock TxCLK. For example, suppose that I/O block 510 is manufactured to sample the receive data RxData on the rising edge of clock IORXCLK. If IORXCLK=RxCLK, then I/O block 510 will sample the receive data on the rising edge of RxCLK. If IORXCLK is equal to the inverse of RxCLK, then I/O block 510 will sample the receive data on the falling edge of RxCLK.

Similarly, suppose I/O block 510 is manufactured to drive the transmit data TxData on the rising edge of clock IOTXCLK. If IOTXCLK=TxCLK, I/O block 510 will drive the transmit data on the rising edge of clock TxCLK. If IOTXCLK is the inverse of TxCLK, then the block 510 will drive the transmit data on the falling edge of clock TxCLK.

OPTION 2. The physical layer device 140.0 expects the system 110 to generate the receive clock RxCLK and the transmit clock TxCLK. In this case, clock IORXCLK is either SYSCLK (buffer 1552 is enabled and inverter 1550 disabled) or the inverse of SYSCLK (inverter 1550 is enabled and buffer 1552 disabled). Clock IOTXCLK is either SYSCLK (buffer 1562 is enabled and inverter 1560 disabled) or the inverse of SYSCLK (inverter 1560 is enabled and buffer 1562 is disabled). The frequency of clocks IORXCLK, IOTXCLK can be adjusted by circuit 1548. Inverters and buffers 1570, 1572, 1580, 1582 are disabled. Either buffer 1576 or inverter 1574 is enabled, depending on whether the received data should be sampled on the rising or falling edge of clock RxCLK. Either buffer 1586 or inverter 1584 is enabled, depending on whether the transmit data should be driven on the rising or falling edge of clock TxCLK.

OPTION 3. The physical layer device generates the receive clock RxCLK, but the transmit clock TxCLK must be generated by system 110. In this case, the clock IORXCLK is generated as in Option 1. The transmit clock IOTXCLK can be generated as in Option 2, or it can equal to RxCLK or the inverse of RxCLK. Buffer 1586 or inverter 1584 is enabled depending on whether the transmit data should be driven on the rising or falling edge of clock TxCLK.

OPTION 4. The physical layer device generates the transmit clock TxCLK, but expects the system 110 to generate the receive clock RxCLK. This is similar to Option 3, with clocks RxCLK and TxCLK interchanged.

The embodiments described above, and in the Addenda below, illustrate but do not limit the invention. The invention is not limited to any particular circuitry or options described for particular embodiments. Additional options and capabilities may be provided consistent with the intended claims. Some embodiments have less capability than the embodiments described above. For example, in some embodiments, the clock signals cannot be configured as described above in connection with FIG. 15. In other embodiments, the clock configuration techniques are applied to non-network circuits. The invention is not limited to any particular circuits, FIFO depths, the number of bits of any particular entries, or any formats. The invention is not limited to FIFOs or any other data structures. The invention is not limited to UTOPIA or the serial interface. The invention is not limited to any particular protocols, to particular software or hardware, or a particular division of functions between software and hardware. Other embodiments and variations are within the scope of the invention, as defined by the appended claims.

Addendum A

Configuration register 610 has a number of bits that are initially defined by configuration pins 240 but can be overwritten by software. These bits specify if the WAN port 120 is to be used for UTOPIA or serial interface. For the serial interface, these bits also define whether ATM/serial block 530, HDLC block 540, or framer block 550 is activated.

The following Table A1 lists some registers in flexible network interface 210. In some embodiments, microprocessor 560 is a MIPS I microprocessor of type LX4180 available from Lexra, Inc., of San Jose, Calif. This microprocessor has a coprocessor interface allowing the microprocessor to read and write coprocessor registers. Some embodiments of the invention use the coprocessor interface to access the registers of Table A1.

TABLE A1
Registers in Configuration Data Block 230

| Reference | | |
|---|---|---|
| number in FIG. | | |
| 6 and the table | | |
| in which the | | |
| register is | | |
| described in | | |
| detail | Register name | Description |
| 620; Table A2 | WAN_control | WAN control register |
| | | (Cbus (control bus) |
| | | accessible, i.e. |
| | | accessible to another |
| | | microprocessor in the |
| | | same integrated circuit |
| | | as flexible interface |
| | | 210) |
| 630; Table A3 | WAN_status0 | Status bits |
| 634: Table A4 | WAN_status1 | Status bits |
| Table A5 | WAN_DMA_cmd | Write port of the |
| | | DMA command FIFO |
| | | 740. When the address |
| | | of this register is |
| | | driven on a |
| | | coprocessor interface |
| | | by processor 560, the |
| | | FIFO logic 708 writes |
| | | the DMA command |
| | | FIFO with the data |
| | | driven on the |
| | | coprocessor interface |
| | | data bus. The register |
| | | may or may not |
| | | actually exist. |
| Table A6 | WAN_DMA_addr | Write port of the 8 |
| | | words deep DMA |
| | | address FIFO 750. |
| | | When the address of |
| | | this register is driven |
| | | on a coprocessor |
| | | interface by processor |
| | | 560, the FIFO logic |
| | | 708 writes the DMA |
| | | address FIFO with the |
| | | data driven on the |
| | | coprocessor interface |
| | | data bus. The register |
| | | may or may not |
| | | actually exist. |
| 640; Table A7 | WAN_DMA_base_addr | This register holds |
| | | DMA base address, |
| | | i.e. the 19 most |
| | | significant bits of the |
| | | address in memory |
| | | 584. These bits are |
| | | concatenated with the |
| | | address bits in DMA |
| | | command FIFO 740 to |
| | | obtain the address for |
| | | the DMA transfer |
| Table A9 | WAN_rx_cmd | Write port of the |
| | | receive command |
| | | FIFO 720. When the |
| | | address of this |
| | | register is driven on |
| | | a coprocessor |
| | | interface by processor |
| | | 560, the FIFO |
| | | logic 708 writes the |
| | | receive command |
| | | FIFO with the data |
| | | driven on the |
| | | coprocessor interface |
| | | data bus. The |
| | | register may or may |
| | | not actually exist |
| Table A10 | WAN_tx_cmd | Write port of transmit |
| | | command FIFO 714. |
| | | When the address of |
| | | this register is driven |
| | | on a coprocessor |
| | | interface by processor |
| | | 560, FIFO logic |
| | | 708 writes the transmit |
| | | command FIFO with |
| | | the data driven on the |
| | | coprocessor interface |
| | | data bus. The register |
| | | may or may not |
| | | actually exist |
| Table A11 | WAN_rx_cmd_done | Read port of receive |
| | | command done FIFO |
| | | 730. When the address |
| | | of this register is |
| | | driven on a |
| | | coprocessor interface |
| | | by processor 560, |
| | | FIFO logic 708 reads |
| | | the receive command |
| | | done FIFO onto the |
| | | coprocessor interface |
| | | data bus. The register |
| | | may or may not |
| | | actually exist |
| Table A12 | WAN_tx_cmd_done | Read port of transmit |
| | | command done FIFO |
| | | 720. Similar to |
| | | WAN_rx_cmd_done |
| | | (described above in |
| | | this table). |
| Table A8 | WAN_DMA_cmd_done | Access port for DMA |
| | | command done FIFO |
| | | 760. Similar to |
| | | WAN_rx_cmd_done |
| | | (described above in |
| | | this table). |
| 644; Table A13 | WAN_IDLE_TX_CMD | Idle cell transmit |
| | | command |
| 650; Table A14 | WAN_IDLE_CNT | Idle cell transmitted |
| | | counter |
| 654; Table A15 | WAN_frame_sizes | Frame size |
| 660; Table A16 | WAN_frame_delimiter | Frame delimiter |
| 664; Table A17 | WAN_frame_delimiter_mask | Frame delimiter mask |
| 670; Table A18 | WAN_frame | WAN frame info |

In the tables below, the “R/W” column indicates if the register bits can be read or written by software, e.g. by microprocessor 560. “X” indicates “don't care”.

TABLE A2
WAN Control Register 620

| Bit field | Name | R/W | Default | Description |
|---|---|---|---|---|
| 31:30 | Lstate | R/W | 10 | 00: run; |
| | | | | 11: halt; (default) |
| | | | | 10: reset, reset the |
| | | | | flexible interface |
| | | | | 210 |
| 29 | Rx_reset | R/W | 0 | Reset receive |
| | | | | interface—this is |
| | | | | a 1-shot that is set |
| | | | | by software and |
| | | | | reset by hardware |
| 28 | Tx_reset | R/W | 0 | Reset transmit |
| | | | | interface—this is |
| | | | | a 1-shot that is set |
| | | | | by software and |
| | | | | reset by hardware |
| 27 | Debug_Write_enable | R/W | 0 | Write enable for |
| | | | | bits 26:24 when |
| | | | | this register is |
| | | | | being written |
| 26:24 | Debug | R/W | 0 | For debug |
| | | | | purposes only |
| 23:11 | Reserved | R | 0 | |
| 10:9 | WAN_configure | R | | Read only |
| | | | | 00: UTOPIA |
| | | | | 01: Serial, |
| | | | | non-HDLC |
| | | | | 11: Serial, HDLC |
| | | | | 10: Cable modem |
| 8 | Write_enable for bit 7 | R/W | | Read back 0 wen |
| | | | | this register is |
| | | | | being read |
| 7 | Busy_bit | R/W | 0 | Used for |
| | | | | communication |
| | | | | between |
| | | | | processor 560 |
| | | | | and another |
| | | | | processor (not |
| | | | | shown) of system |
| | | | | 110. Not pertinent |
| | | | | to this invention. |
| 6 | Write enable for bits | R/W | | Read back 0 |
| | [5:3] when this | | | when this is being |
| | register is being | | read. | |
| | written | | | |
| 5 | ODD_PRTY | R/W | 0 | 1: odd parity for |
| | | | | UTOPIA |
| | | | | 0: even parity |
| 4 | EN_UTOPIA_PRTY | R/W | 0 | Enable Parity for |
| | | | | UTOPIA |
| | | | | Interface |
| 3 | EN_IDLE_INSERTION | R/W | 0 | This bit controls |
| | | | | the behavior of |
| | | | | ATM blocks 520, |
| | | | | 530 if the |
| | | | | transmit queue |
| | | | | 770 is empty. If |
| | | | | this bit is set, |
| | | | | blocks 520, 530 |
| | | | | insert idle cells. |
| 2 | EN_TX_TRQ_ID | R/W | 0 | Enable bit to |
| | | | | write a transmit |
| | | | | ready queue (not |
| | | | | shown) in buffer |
| | | | | manager 590. |
| | | | | Buffer manager |
| | | | | 590 has 4 such |
| | | | | queues for |
| | | | | different |
| | | | | priorities. If this |
| | | | | bit is 1, a write to |
| | | | | this register will |
| | | | | update bits 1:0. |
| 1:0 | TX_TRQ_ID | R/W | 00 | ID for reading |
| | | | | Transmit ready |
| | | | | queue. |

On power-up, the Lstate is “halt”. The software running on processor 560 programs these 2 bits to “run” to start the interface 210. The processor 560 software can program these bits to binary 10 to reset the interface 210 and the coprocessor interface. On completion of the reset sequence, the hardware will set Lstate to “halt” (default). When a reset is issued all pending commands in the FIFOs 740, 720, 714 will be flushed. A DMA command that has already started will be allowed to complete; the reset sequence will wait until the transfer is finished.

TABLE A3
WAN_status0 Register 630

| Bit field | Name | R/W | default | Description |
|---|---|---|---|---|
| 31:16 | reserved | | | |
| 14 | Dma_cmd_doneq_empty | R | 1 | DMA command |
| | | | | done queue 760 |
| | | | | empty |
| 13 | Dma_cmdq_full | R | 0 | DMA command |
| | | | | queue 740 full |
| 12 | Tcmd_doneq_empty | R | 1 | Transmit |
| | | | | command done |
| | | | | queue 724 is |
| | | | | empty. |
| 11 | Tcmdq_full | R | 0 | Transmit |
| | | | | command queue |
| | | | | 714 is full. |
| 10 | Rcmd_doneq_empty | R | 1 | Receive |
| | | | | command done |
| | | | | queue 730 is |
| | | | | empty. |
| 9 | Rcmdq_full | R | 0 | Receive |
| | | | | command queue |
| | | | | 720 is full |
| 8 | TFQ_ACK | R | 1 | Transmit free |
| | | | | queue (a buffer |
| | | | | manager queue) |
| | | | | acknowledge. |
| 7 | TX_ACK | R | 1 | Transmit ready |
| | | | | queue (a buffer |
| | | | | manager queue) |
| | | | | ack. |
| | | | | 1 = can read |
| | | | | from TXRD [1:0] |
| | | | | 0 = cannot read |
| | | | | from TXRD |
| | | | | [1:0] - buffer |
| | | | | manager pre- |
| | | | | reading the |
| | | | | queue. |
| 6:3 | TRQ_empty | R | 0xF | Transmit ready |
| | | | | queue (buffer |
| | | | | manager) status |
| | | | | 1: Empty |
| | | | | 0: Non-empty |
| | | | | bit 3: TRQ0, bit |
| | | | | 4: TRQ1, |
| | | | | bit 5: TRQ2, bit |
| | | | | 6: TRQ3 |
| 2 | Reserved | R | 0 | |
| 1 | RX_RTN_ACK | R | 1 | Receive ready |
| | | | | queue (buffer |
| | | | | manager) |
| | | | | acknowledge |
| | | | | 1 = can write into |
| | | | | RXRD [1:0] |
| | | | | register |
| | | | | 0 = cannot write |
| | | | | into RXRD [1:0] |
| | | | | register |
| | | | | (previous write in |
| | | | | progress). |
| 0 | Rfrq_empty | R | 1 | Ready free queue |
| | | | | fullness (buffer |
| | | | | manager) |
| | | | | 1 = empty, 0 = |
| | | | | non-empty |

TABLE A4
WAN_Status1 Register 634

| Bit field | Name | R/W | default | Description |
|---|---|---|---|---|
| 25:22 | Tcmd_done qfullness | R | 0 | Transmit command |
| | | | | done queue |
| | | | | 724 fullness: |
| | | | | 0 = empty |
| | | | | 8 = full |
| 21:18 | Rcmd_done_qfullness | R | 0 | Receive command |
| | | | | done queue |
| | | | | 730 fullness: |
| | | | | 0 = empty |
| | | | | 8 = full |
| 17:13 | Dma_done_qfullness | R | 0 | DMA command |
| | | | | done queue |
| | | | | 760 fullness: |
| | | | | 0 = empty |
| | | | | 8 = full |
| 12:8 | Dma_qfullness | R | 0 | DMA command |
| | | | | queue 740 |
| | | | | fullness: |
| | | | | 0 = empty |
| | | | | 8 = full |
| 7:4 | transmit_qfullness | R | 0 | transmit command |
| | | | | queue 714 |
| | | | | fullness: |
| | | | | 0 = empty |
| | | | | 8 = full |
| 3:0 | receive_qfullness | R | 0 | Receive command |
| | | | | queue 720 |
| | | | | fullness: |
| | | | | 0 = empty |
| | | | | 8 = full |

DMA, WAN receive and WAN transmit commands can execute concurrently. Typically, a WAN transmit command is issued from FIFO 714 to operate on data in the transmit bank of memory 594 while a concurrent WAN receive command is issued from FIFO 720 to receive data into the receive bank of memory 594. A DMA command transfers data into or out of these banks. An arbiter (not shown) schedules the access to the WAN side port of memory 594 between the DMA engine 596 and I/O block 510. In some embodiments, the DMA cannot be backed off once started and hence a small FIFO (not shown) is provided between I/O block 510 and the memory 594. The bandwidth required by I/O block 510 and DMA engine 596, is less than the available bandwidth on the WAN side port.

In some embodiments, the receive and transmit done queues 730, 724 and the DMA command done queue 760 are each 8 entries deep.

The WAN_DMA_cmd register is the write port of the 8 deep DMA command FIFO 740. A write to the register writes to the youngest entry in the queue. A read from the register returns the command currently in progress (or if no command is in progress, the last executed command). A write to the WAN_DMA_cmd register is accompanied with a write to the WAN_DMA_addr register, which is the write port of FIFO 750 of 8 words deep. Each entry contains the 32-bit word address that is to be used by the DMA command. A read from the register returns 21 LSBs of the memory 584 address used by the current DMA command. The format of a DMA command and the DMA command register WAN_DMA_cmd is shown in the following Table A5:

TABLE A5
DMA Command FIFO 740

| Bit field | Name | R/W | Default | Description |
|---|---|---|---|---|
| 15 | Ldst | R/W | X | 0: load WAN memory 594 from |
| | | | | external memory |
| | | | | 1: store WAN memory 594 to |
| | | | | external memory 584. |
| 14:10 | wcount | R/W | X | Number of 32-bit words to transfer |
| | | | | 0: reserved |
| 9:0 | addr | R/W | X | WAN memory 594 word address. |

These fields are as follows:

Ldst

To load data from external memory 584 set to 1; to store data to external memory 584 set to 0.

addr

Address in memory 594. Once DMA is done this field is inserted into the DMA command done FIFO 760 (Table A8).

wcount

This field specifies the number 32-bit words to be transferred to/from memory 584. If more than 32 words are to be DMA'ed then multiple DMA commands can be issued.

TABLE A6
Format of an Address in DMA Address FIFO 750

| Bit field | Name | R/W | Default | Description |
|---|---|---|---|---|
| 22:2 | addr | R/W | X | Physical word address of external |
| | | | | memory 584 |
| 1:0 | reserved | R | 0 | Not present in hardware. Is driven |
| | | | | as zero for DMA. |

TABLE A7
WAN_DMA_base_addr register 640

| Bit field | Name | R/W | Default | Description |
|---|---|---|---|---|
| 31:23 | Base_addr | R/W | 0 | Physical base address in external |
| | | | | memory 584 |
| 22:0 | reserved | R | 0 | Not present in hardware. Is |
| | | | | driven as zero for DMA. |

TABLE A8
Entry in DMA Command Done FIFO 760. and the
WAN_DMA_cmd_done_Register

| Bit field | Name | R/W | Default | Description |
|---|---|---|---|---|
| 10 | Ldst | R | X | This DMA was for: 1—load, 0—store |
| 9:0 | Addr | R | X | WAN memory 594 address |

The WAN_rx_cmd register is an access port to the WAN receive command FIFO 720. A read from the port returns the command that is in progress (or the last command executed if the command queue is empty).

TABLE A9
Entry of Receive Command in FIFO 720, and
Receive Command Register WAN_rx_cmd

| Bit field | Name | R/W | Default | Description |
|---|---|---|---|---|
| 17 | Start | R/W | X | To receive data from beginning of |
| | of Cell | | | cell. I/O 510 will skip (discard) data |
| | | | | till start of cell or frame. |
| | | | | For UTOPIA interface, check |
| | | | | RxCLAV when this bit is set. |
| 16:10 | Bcount | R/W | X | Max. number of bytes to be received. |
| | | | | 0: reserved |
| | | | | For UTOPIA, if bit 17 is set, the |
| | | | | Bcount is at least 4. |
| | | | | I/O 510 will write, to receive FIFO |
| | | | | 780, “Bcount” bytes or till the end of |
| | | | | cell or frame, whichever is smaller. |
| 9:0 | Addr | R/W | X | WAN memory 594 word address to |
| | | | | store the received data. |

The WAN_tx_cmd register is an access port to the transmit command FIFO 714. A read from the port returns the command that is in progress (or the last command executed if the command queue is empty). The WAN_tx_cmd register is divided into the following bit fields:

TABLE A10
Transmit Command in FIFO 714 and Transmit
Command Register WAN_tx_cmd

| Bit field | Name | R/W | Default | Description |
|---|---|---|---|---|
| 19 | Frame | R/W | X | 0—Invalid |
| | bit | | | 1—Valid |
| | valid | | | The frame bit is transmitted at start |
| | | | | of cell or frame over serial |
| | | | | interface if this bit is 1 and if |
| | | | | WAN_frame [5] is 1. |
| | | | | WAN_frame [5] is bit 5 of frame |
| | | | | register 670 (Table A18). |
| 18 | Frame | R/W | X | Frame bit value. Valid only if bit |
| | bit | | | 19 is 1. |
| | value | | | |
| 17 | End of | R/W | X | Beginning of cell. For UTOPIA |
| | Cell | | | interface, generate TxSOC when |
| | | | | transmitting the first byte. |
| | | | | For framer 550, a frame pulse is |
| | | | | generated on line TXSOF if |
| | | | | WAN_frame [4] and |
| | | | | WAN_frame [5] |
| | | | | (i.e. bits 4 and 5 in Table A18 |
| | | | | below) are both 1. |
| | | | | For HDLC, it indicates end of |
| | | | | frame. Block 540 will append CRC |
| | | | | at the end of transmission. |
| 16:10 | Bcount | R/W | X | Number of bytes to transmit. |
| | | | | 0: reserved |
| 9:0 | Addr | R/W | X | Memory 594 address of the data |
| | | | | to be transmitted. |

The WAN_rx_cmd_done register is an access port to the WAN receive command done FIFO 730. A read from the port returns the oldest command that was inserted into the queue.

TABLE A11
Entry in Receive Command Done FIFO
730 and the WAN_rx_cmd_done Register

| Bit field | Name | R/W | Default | Description |
|---|---|---|---|---|
| 24 | End of Frame | R | X | 0—not end of frame |
| | | | | 1—end of frame |
| 23 | Frame bit valid | R | X | 0—Invalid |
| | | | | 1—Valid |
| 22 | Frame bit value | R | X | Frame bit value. Valid |
| | | | | only if bit 23 is 1 |
| 21:17 | Status | R | X | Receive Status: |
| | | | | For UTOPIA: |
| | | | | [21:20]: reserved |
| | | | | [19]: data dropped when |
| | | | | searching RxSOC |
| | | | | [18]: For UTOPIA, this bit |
| | | | | is set when unexpected |
| | | | | RxSOC is received. |
| | | | | [17]: parity error |
| | | | | For HDLC/Framer (blocks |
| | | | | 540, 550): |
| | | | | [21]: OVERRUN ERROR |
| | | | | [20]: OCTET ERROR |
| | | | | [19]: FRAME ABORT |
| | | | | [18]: FRAME ERROR |
| | | | | [17]: FCS ERROR |
| 16:10 | Bcount | R | X | Number of bytes received |
| 9:0 | Addr | R | X | Memory 594 address of |
| | | | | the received data. |

The WAN_tx_cmd_done register is an access port to the WAN transmit command done FIFO 724. A read from the port returns the oldest entry that was inserted into the FIFO.

TABLE A12
An Entry in Transmit Command Done FIFO 724,
and the WAN_tx_cmd_done Register

| Bit field | Name | R/W | Default | Description |
|---|---|---|---|---|
| 17 | status | R | X | Underrun happened when |
| | | | | transmitting |
| 16:10 | Bcount | R | X | Number of bytes transmitted. |
| 9:0 | Addr | R | X | Memory 594 address storing |
| | | | | the data to be transmitted. |

WAN IDLE CELL INSERTION register 644 (“WAN_IDLE_TX_CMD”): When port 120 is configured for Utopia, and transmit command queue 714 is empty and en_idle_insertion bit (bit 3 in Table A2) is set, the I/O block 510 uses the command in this register to transmit an idle cell.

TABLE A13
WAN_IDLE_TX_CMD Register 644

| Bit field | Name | R/W | Default | Description |
|---|---|---|---|---|
| 17 | Start | R/W | 0 | Generate SOC for this command |
| | of Cell | | | |
| 16:10 | Bcount | R/w | 0 | Number of bytes to be |
| | | | | transmitted. |
| 9:0 | Addr | r/w | 0 | WAN memory 594 address to |
| | | | | store the frame/cell to be |
| | | | | transmitted. |

WAN IDLE CELL INSERTION Counter register 650 (“WAN_IDLE_CNT”): This register counts the number of idle cell transmitted. It is cleared on read.

TABLE A14
WAN_IDLE_CNT Register 650

| Bit field | Name | R/W | Default | Description |
|---|---|---|---|---|
| 31:16 | Reserved | | | |
| 15:0 | Count | R | 0 | Number of idle cells transmitted. |
| | | | | Clear on Read of this register |

TABLE A15
WAN_frame_sizes Register 654

| Bit field | Name | R/W | Default | Description |
|---|---|---|---|---|
| 31:15 | reserved | R | 0 | |
| 14:0 | Frame_size | R/W | 0 | Total frame size in bits, |
| | | | | including starting delimiter, |
| | | | | payload and CRC. Used for both |
| | | | | of FIGS. 13 and 14 |

TABLE A16
WAN_frame_delimiter Register 660

| Bit field | Name | R/W | Default | Description |
|---|---|---|---|---|
| 31:0 | Delimiter_pattern | R/W | 0 | Delimiter pattern that is for |
| | | | | each frame before the |
| | | | | payload. In some |
| | | | | embodiments, framer 550 |
| | | | | strips the delimiter before |
| | | | | writing the data to receive |
| | | | | FIFO 780. In other |
| | | | | embodiments, framer 550 |
| | | | | does not strip the delimiter. |
| | | | | In some embodiments, |
| | | | | framer 550 appends the |
| | | | | delimiter to transmit data in |
| | | | | transmit FIFO 770. In other |
| | | | | embodiments, framer 550 |
| | | | | does not append the |
| | | | | delimiter; the delimiter is |
| | | | | expected to be in the |
| | | | | transmit FIFO; the delimiter |
| | | | | can be placed into the |
| | | | | transmit FIFO by |
| | | | | microprocessor 560. The |
| | | | | delimiter pattern itself |
| | | | | occupies the bit positions |
| | | | | corresponding to the bits |
| | | | | that are 1 in the delimiter |
| | | | | mask. The other bits are |
| | | | | ignored. |
| | | | | The framer 550 |
| | | | | looks for this delimiter |
| | | | | pattern regardless of |
| | | | | WAN_frame [1:0]. If |
| | | | | software changes the value |
| | | | | of WAN_frame [1:0], it |
| | | | | should reverse the delimiter |
| | | | | pattern accordingly. |

TABLE A17
WAN_frame_delimiter_mask Register 664

| Bit field | Name | R/W | Default | Description |
|---|---|---|---|---|
| 31:0 | Delimiter_mask | R/W | 0 | Delimiter mask. All the bits |
| | | | | corresponding to the |
| | | | | delimiter should be 1; the |
| | | | | rest of the bits can be 0. |
| | | | | Any FEBE bit positions |
| | | | | should occupy the LSBs |
| | | | | and the mask value is 0. |
| | | | | The next mask bits |
| | | | | correspond to the delimiter |
| | | | | and should be 1. The upper |
| | | | | bits are unused and should |
| | | | | be 0. |

The WAN_frame_delimiter and WAN_frame_delimiter_mask together help the framer 550 determine the start of a frame. Further, as described below, the mask register 664 can be programmed to cause the framer 550 to store the payload of each frame in RX FIFO 780 on a 32-bit boundary.

The frame format may specify that the delimiter is followed by error bits which precede the payload. We call the error bits “FEBE”. This acronym is taken from ISDN, where it stands for “far end block error”. R. Freeman “Telecommunication System Engineering” (3rd ed. 1996), p. 682, incorporated herein by reference. (The invention is not limited to ISDN.)

To cause the framer to store the payload on a 32-bit boundary, delimiter mask register 664 can be programmed as follows. Suppose the delimiter size is 14 bits, and the FEBE size is 10 bits. The delimiter mask register can be set to the binary value

0000 0000 1111 1111 1111 1100 0000 0000 (here the most significant bit is written first).

In this value, the fourteen 1's (corresponding to the delimiter) and the next ten 0's (corresponding to FEBE) are right-aligned. The 8 LSBs are 0. This indicates to framer 550 that when the framer detects a start of frame, the framer must write the first 8 bits (MSBs) of the corresponding RX FIFO entry with 0. The frame (starting with the frame delimiter) should be written next. As a result, the payload will be word-aligned (i.e. stored on a 32-bit boundary).

In another example, suppose the delimiter is 14 bits, and the FEBE is 34 bits. Let S_FEBE be the size of FEBE, i.e. S_FEBE=34. If S_FEBE is divided by 32, the remainder R_FEBE is 2. Delimiter mask register 664 can be written with the value

0000000000000000111 1111111111100

Here, the fourteen 1's (corresponding to the delimiter) and the next two 0's (FEBE) are right-aligned. Framer 550 will store each frame starting with the 17th bit of the corresponding RX FIFO entry. The first 16 bits of the entry will be written with 0. The payload will be stored on a word boundary.

If the delimiter size is some value S_D, then the mask register can be written with a value in which the R_FEBE LSBs are 0's and the next S_D bits are 1's. This will cause the payload to be stored on the 32-bit boundary. This applies to frame formats that have no FEBE (R_FEBE=0). Of course, the mask register does not have to be programmed this way. Also, this embodiment does not limit the invention.

TABLE A18
WAN_frame Register 670

| Bit field | Name | R/W | Default | Description |
|---|---|---|---|---|
| 31 | Frame pulse | R/W | 0 | 0—Active High |
| | | | | 1—Active Low |
| 30:8 | Reserved | R | 0 | |
| 7:6 | Rx_Tx_enable | R/W | 00 | 00—Receive and Transmit |
| | | | | disable |
| | | | | 01—Receive Enable |
| | | | | 10—Transmit Enable |
| | | | | 11—Receive and Transmit |
| | | | | Enabled |
| 5 | Frame bit | R/W | 0 | 0—No frame bit, e.g., E1 |
| | | | | 1—Frame bit present, e.g., |
| | | | | T1 |
| 4 | Frame Mode | R/W | 0 | 0—Unframed mode |
| | | | | 1—Frame mode, e.g, T1 |
| 3 | HDLC_IDLE | R/W | 0 | 0—7E |
| | | | | 1—FF |
| 2 | HDLC_CRC | R/W | 0 | CRC type in HDLC (used |
| | | | | by block 540): 0—CRC16 |
| | | | | 1—CRC32 |
| 1 | Tx MSB first | R/W | 0 | 0—MSB first |
| | | | | 1—LSB first |
| | | | | See also |
| | | | | WAN_frame_delimiter |
| | | | | definition (Table A16) |
| 0 | Rx MSB first | R/W | 0 | 0—MSB first |
| | | | | 1—LSB first |
| | | | | See also |
| | | | | WAN_frame_delimiter |
| | | | | definition (Table A16) |

When either the transmit command queue 714 or the receive command queue 720 is empty, an interrupt is generated to microprocessor 560.

The framer interface in is accomplished through a combination of hardware and software.

On the receive side, framer 550 provides the data to FIFO 780 after there is a delimiter match. The data before the delimiter match are discarded. It is the responsibility of software to check FEBE field, CRC, extract EOC (embedded operations channel; see R. Freeman “Telecommunications System Engineering” (1996), p. 682) and end-of-frame data (ending delimiter).

On the transmit side, the software prepares the delimiter and FEBE, indicates the beginning of frame through the transmit command, prepares the payload, CRC, and end-of-frame data. Software is responsible for inserting idle cells or any end-of-frame cells/data (the idle cell registers that have been defined are for the Utopia interface only, not the framer).

Framer 550 does the following:

1. With Frame Sync Pulse

1.1. Receive

Framer 550 uses the frame sync pulse on line RXSOF to identify the beginning of a frame. The rest of the behavior is the same as in the case without the sync pulse (see below).

1.2. Transmit

The framer generates a frame sync pulse on line TXSOF if specified in WAN_frame[5:4] (both should be 1). See Table A18. The rest of the behavior is the same as in the case without the sync pulse (see below).

2. Without Frame Sync Pulse

2.1. Receive

The framer looks for the delimiter based on the delimiter pattern and mask. If it finds a delimiter match, it passes a portion of the delimiter and the rest of the data to software (the delimiter match can be an exclusive NOR of the incoming bit stream followed by an AND). Depending on the WAN_frame_delimiter_mask, the framer discards some of the delimiter pattern itself. This provides a mechanism for the framer to provide FEBE/or other similar bits to software. This also can be used to byte-align payload data. Once a delimiter match is found, the framer ignores the rest of the frame (based on the frame size) and looks for a delimiter once more. In case there is no match, the framer renews the search till a delimiter match is found. If there is a match, the above-mentioned behavior continues.

2.2. Transmit

Software identifies the beginning of a new frame by setting the start of cell bit in the transmit command (bit 17, Table A10). If specified, the framer generates a frame sync pulse. The data is sent out serially without any change.

Some embodiments use a specific frame format with each frame being 432 bytes. This format uses an 8-bit header (7-bit delimiter and a 1-bit FEBE) before the payload that consists of 8 ATM cells. After the payload, there are EOC, CRC and end-of-frame (EOF) fields. The delimiter mask programmed in the framer is 0x000000fe. The framer passes 1 byte to software with the FEBE being the LSB. Byte-aligned payload starts next. The framer passes on all the bytes indicated by the frame size to software. This includes the EOC, CRC, and RDI fields (Remote Defect Indicator).

After the initial delimiter match, the framer suspends the match check for 432 bytes and expect to find another delimiter match. If there is no match, the framer looks for a match from that point onward.

Addendum B

UTOPIA and Serial Interfaces (FIGS. 3, 4)

UTOPIA (FIG. 3)

The following signals are defined as required for the Transmit interface.

TxData[7 . . . 0]—Data. Byte-wide true data driven from ATM (from system 110) to PHY layer. TxData[7] is the MSB.

TxSOC—Start Of Cell. Active high signal asserted by the ATM layer (system 110) when TxData contains the first valid byte of the cell.

TxEnb*—Enable. Active low signal asserted by the ATM layer during cycles when TxData contains valid cell data.

TxFull*/TxClav—Full/Cell Available. For octet-level flow control, TxFull* is an active low signal from PHY to ATM layer, asserted by the PHY layer to indicate a maximum of four more transmit data writes will be accepted. (Four more write cycles represent at most 4 more octets for an 8-bit interface, and 8 more octets for a 16-bit interface.) For cell-level flow control, TxClav is an active high signal from PHY to ATM layer, asserted by the PHY layer to indicate it can accept the transfer of a complete cell.

TxClk—Data transfer/synchronization clock provided by the ATM layer to the PHY layer for synchronizing transfers on TxData.

The following signals are defined as optional for the Transmit interface.

TxPrty—Parity. TxPrty is the odd parity bit over TxData[7:0], driven by the ATM layer.

TxRef*—Transmit Reference. Input to the PHY layer for synchronization purposes (e.g. 8 kHz marker, frame indicator, etc.).

The following signals are defined as required for the Receive interface.

RxData[7 . . . 0]—Data. Byte-wide data driven from PHY to ATM layer. RxData[7] is the MSB. Note, to support multiple PHY configurations, it is recommended that RxData be tri-stateable, enabled only when RxEnb* is asserted.

RxSOC—Start Of Cell. Active high signal asserted by the PHY layer when RxData contains the first valid byte of a cell. Note, to support multiple PHY configurations, it is recommended that RxSOC be tri-stateable, enabled only in cycles following those with RxEnb* asserted.

RxEnb*—Enable. Active low signal asserted by the ATM layer to indicate that RxData and RxSOC will be sampled at the end of the next cycle. Note, to support multiple PHY configurations, RxEnb* should be used to tri-state RxData and RxSOC PHY layer outputs. RxData and RxSOC should be enabled only in cycles following those with RxEnb* asserted.

RxEmpty*/RxClav—Empty/Cell Available. For octet-level flow control, RxEmpty* is an active low signal asserted by the PHY layer to indicate that in the current cycle there is no valid data for delivery to the ATM layer. For cell-level flow control, RxClav is an active high signal asserted by the PHY layer to indicate it is has a complete cell available for transfer to the ATM layer. In both cases, this signal indicates cycles when there is valid information on RxData/RxSOC.

RxClk—Clock. Transfer/synchronization clock from the ATM layer to the PHY layer for synchronizing transfers on RxData.

The following signals are defined as optional for the Receive interface.

RxPrty—Parity. RxPrty is odd parity for RxData[7:0], driven by the PHY layer.

RxRef*—Receive Reference. Output from the PHY layer for synchronization purposes (e.g. 8 kHz marker, frame indicator, etc.).

Serial Interface (FIG. 4)

Transmit signals:

TXD—Data (1 -bit data bus).

TXSOF—Transmit Start of Frame.

TXCK—Transmit clock.

Receive signals:

RXD—Data (1-bit data bus).

RXSOF—Transmit Start of Frame.

RXCK—Transmit clock.

A serial interface may have multiple channels. The transmit and receive signals described above can be provided on each channel. For example, a preliminary data sheet for the chip set part numbers G7070-174-001DA, G7070-174-002DA available from GlobeSpan, Inc. of Red Banks, N.J., dated May 25, 1999, and entitled “ADSL Multi-Mode CPE; Chip Set with Framer”, incorporated herein by reference, describes in page 10 a serial interface with two channels A and B. One of these channels can be used for user data, and the other channel for management data (e.g. EOC in ISDN, or the supervisory signaling channel in DS1/T1 frames).

In some embodiments, the pins of port 120 are multiplexed between UTOPIA and Serial interfaces as shown in the following table:

| Pins of Port 120 | Utopia | Serial Interface |
|---|---|---|
| Pin 1 | TxData [0] | TxD |
| Pin 2 | TxData [1] | TxSOF |
| Pin 3 | RxData [0] | RxD |
| Pin 4 | RxData [1] | RxSOF |
| Pin 5 | RxData [2] | RxCK |
| Pin 6 | RxData [3] | TxCK |

Other pin assignments can also be used.

In some embodiments, the pins of port 120 can be configured by block 230 for more than two interfaces.

1. An apparatus comprising:
a port for receiving and/or transmitting network data;
a first circuit for providing a first signal identifying one of a plurality of data formats, wherein the first signal is to be defined by a signal provided to the apparatus from outside of the apparatus, and the first signal is changeable without re-manufacturing the apparatus; and
a hardwired (non-software-executing) circuit for processing data according to any one of said formats, wherein the circuit is responsive to the first signal to process data according to the format specified by the first signal.

2. The apparatus of claim 1 wherein:
in a first one of said formats, the data are fixed size cells; and
in a second one of said formats, the data are frames which are different from the fixed size cells in allowable size or sizes, and/or in a starting delimiter format, and/or in an ending delimiter format, and/or in a check sum format.

3. The apparatus of claim 2 wherein:
in the first format, the data are fixed size cells having no starting delimiter; and
for the second format, the first signal indicates whether the frames have a starting delimiter.

4. The apparatus of claim 1 wherein the first signal is defined by a signal on one or more external pins of the apparatus, and/or by software executed by the apparatus, the software being changeable without re-manufacturing the apparatus.

5. A method comprising:
generating a first signal identifying one of a plurality of formats for network data received and/or transmitted on a port of an apparatus;
receiving and/or transmitting network data on the port, and processing the data by a hardwired circuit as having the format identified by the first signal;
wherein the first signal is defined by a signal provided to the apparatus from outside of the apparatus, and the first signal is changeable without re-manufacturing the apparatus.

6. The method of claim 5 wherein:
in one of said formats, the data are fixed size cells; and
in another one of said formats, the data are frames which are different from the fixed size cells in allowable size or sizes, and/or in a starting delimiter format, and/or in an ending delimiter format, and/or in a check sum format.

7. The method of claim 5 wherein:
in one of said formats, the data are fixed size cells having no starting delimiter; and
in another one of said formats, the data are frames, and the first signal indicates whether the frames have a starting delimiter.

8. The method of claim 5 wherein the first signal is changeable by software executed by the apparatus, the software being changeable without re-manufacturing the apparatus.

9. An apparatus comprising:
a port for receiving data from a network via a physical layer device and/or transmitting data to a network via a physical layer device;
a first circuit for providing a first signal identifying one of types of interfaces between the port and physical layer devices, wherein the first signal is to be defined by a signal provided to the apparatus from outside of the apparatus, and the first signal is changeable without re-manufacturing the apparatus; and
a hardwired (non-software-executing) circuit, responsive to the first signal, for receiving and/or transmitting data on said port according to the type of interface specified by the first signal.

10. The apparatus of claim 9 wherein one of said types of interfaces has a plurality of pins on which a plurality of data bits are received or transmitted in parallel, and another one of said types of interface provides (i) only one pin on which the data are received serially one bit at a time and/or (ii) only one pin on which the data are transmitted serially one bit at a time.

11. A method comprising:
generating a first signal identifying one of types of interfaces for transferring data between a port of a network data processing system and a physical layer device, wherein the first signal is to be defined by a signal provided to the network data processing system from outside of the network data processing system, and the first signal is changeable without re-manufacturing the network data processing system;
a port for receiving data from a network via a physical layer device and/or transmitting data to a network via a physical layer device;
receiving and/or transmitting data on said port by a hardwired (non-software-executing) circuit according to the type of interface specified by the first signal.

12. The method of claim 11 wherein one of said types of interfaces has a plurality of pins on which a plurality of data bits are received or transmitted in parallel, and another one of said types of interface provides (i) only one pin on which the data are received serially one bit at a time and/or (ii) only one pin on which the data are transmitted serially one bit at a time.

13. An apparatus comprising:
one or more terminals for carrying data, wherein the data are provided on the one or more terminals on a rising edge or a falling edge of a first clock signal; and
a first circuit for providing a first signal indicating whether the data are to be provided on the falling or rising edge of the first clock signal.

14. The apparatus of claim 13 wherein the first signal is defined by a signal provided to the apparatus from outside of the apparatus, and the first signal is changeable without re-manufacturing the apparatus.

15. The apparatus of claim 13 wherein the one or more terminals are one or more external pins for receiving or transmitting network data, and the first signal defines whether the first clock signal is (i) to be received or transmitted with the data or (ii) to be generated by the apparatus.

16. The apparatus of claim 13 wherein:
the one or more terminals are one or more external pins for receiving network data;
the apparatus further comprises one or more external pins for transmitting network data on a rising or falling edge of a second clock signal;
the first signal indicates whether the second clock signal is to be generated from the first clock signal or from a third clock signal received by the apparatus on an external pin other than the one or more external pins of receiving the network data and the one or more external pins for transmitting the network data.

17. A method comprising:
generating a first signal indicating whether data are to be provided on one or more terminals on a falling or rising edge of a first clock signal; and
providing data on the one or more terminals in accordance with the first signal and the clock signal.

18. The method of claim 17 wherein the first signal is defined by a signal provided to an apparatus having the one or more terminals from outside of the apparatus, and the first signal is changeable without re-manufacturing the apparatus.

19. The method of claim 17 wherein the one or more terminals are one or more external pins for receiving or transmitting network data by an apparatus, and the first signal defines whether the first clock signal is (i) to be received or transmitted with the data or (ii) to be generated by the apparatus.

20. The method of claim 17 wherein:
the one or more terminals are one or more external pins for receiving network data by an apparatus;
the apparatus further comprises one or more external pins for transmitting network data on a rising or falling edge of a second clock signal;
the first signal indicates whether the second clock signal is to be generated from the first clock signal or from a third clock signal received by the apparatus on an external pin other than the one or more external pins of receiving the network data and the one or more external pins for transmitting the network data.
